(19) United States
(12) Patent Application Publication
(10) Pub. No.: US 2026/0134356 A1
(43) Pub. Date: May 14, 2026

(54) AUTOMATED HITCHHIKING

(71) Applicant: Telefonaktiebolaget LM Ericsson (publ), Stockholm (SE)

(72) Inventors: Henning BRANDES, Aachen (DE); Laura SPYCHER, Herzogenrath (DE); Karsten GEORGE, Herzogenrath (DE)

(73) Assignee: Telefonaktiebolaget LM Ericsson (publ), Stockholm (SE)

(21) Appl. No.: 19/121,138

(22) PCT Filed: Nov. 15, 2022
(86) PCT No.: PCT/EP2022/081940

§ 371 Date: Apr. 15, 2025

(51) Int. Cl. G06Q 10/02; G06Q 50/40; G06V 10/10; G06V 30/14

(52) U.S. Cl. CPC G06Q 10/02; G06Q 50/40; G06V 10/16; G06V 30/14; G06V 2201/08

(57) ABSTRACT

The application relates to a method carried out at a hitchhiking management entity wherein a ride offer is received from a first subscriber and a hitchhike request is received from a requesting subscriber including a desired destination. Furthermore optical data are received showing a surrounding of the current location of the requesting subscriber. In the optical data a marker and a vehicle is identified providing a possible ride. A current route is determined for the vehicle and it is determined whether the current route of the vehicle has a drop off location closer to the desired destination than the current location, wherein in the affirmative, a reservation offer is provided to the requesting subscriber indicating reservation information comprising at least an identifier of the at least one vehicle providing the possible ride.

### TECHNICAL FIELD

The present application relates to a method for operating a hitchhiking management entity itself, to a computer program comprising program code and to a carrier comprising the computer program.

### BACKGROUND

There is an increasing need for car sharing, especially in large urban agglomerations as owning an own vehicle may not be very practical in many cities. Furthermore, environmental benefits can be realized in those agglomerations as the number of vehicles on the road reduces when car sharing is used.

Furthermore, carpooling or ride sharing or hitchhiking is known, but existing solutions like Uber have the drawback that a spontaneous ride is hardly possible. By way of example contact information has to be exchanged beforehand and every delay creates an uncomfortable waiting situation, by way of example if a driver underestimated the traffic situation or the guest had an unforeseeable incident. Additionally the driver needs to find a parking place for boarding in a crowded area. In such a situation the delay causes extra pain. Existing systems cannot be used spontaneously. By way of example, a person coming out of a supermarket with fully packed bags and finding out that it is raining will not find it very comfortable to arrange and wait for a ride. Furthermore, drivers in a situation such as provided by Uber will have to drive an extra route for the guest. Compared to a hitchhiking situation this is usually not a route that the driver would have gone anyway.

### SUMMARY

Accordingly a need exists to overcome the problems mentioned above and to provide an efficient system by which a user of a hitchhiking system can get a spontaneous and easy ride.

This need is met by the features of the independent claims. Further aspects are described in the dependent claims.

According to a first aspect a method carried out at a hitchhiking management entity is provided, wherein the method comprises the step of receiving, from at least a first subscriber driving a vehicle among a plurality of subscribers, a ride offer including a current route to a corresponding destination. The hitchhiking management entity furthermore receives from a requesting subscriber from the plurality of subscribers a hitchhike request comprising a current location of the requesting subscriber and a desired destination of the requesting subscriber. Furthermore, optical data is received from at least one of the plurality of subscribers, wherein the optical data shows a surrounding of the current location of the requesting subscriber. The method further comprises the step of identifying at least one vehicle providing a possible ride based on at least one marker which is provided in the optical data and which is provided on one of the vehicles from the first subscribers. The current route of the identified at least one vehicle is determined and furthermore it is determined whether the current route of the at least one vehicle has a drop off location closer to the desired destination than the current location. If this is the case, a reservation offer is provided to the requesting subscriber which indicates reservation information containing at least an identifier of the at least one vehicle providing the possible ride.

Furthermore the corresponding hitchhiking management entity is provided comprising memory and at least one processing unit, wherein the memory contains instructions executable by the at least one processing unit, wherein the hitchhiking management entity is configured to work as described above or as described in further detail below.

With the claimed method a hitchhiking situation is automated in a very effective way and a possible ride can be offered in a fraction of time. The optical data such as image data include markers provided on a vehicle and the hitchhiking management entity obtains information about the desired destination and about the route of the vehicle identified in the image data. The entity checks whether the drop off location is closer to the desired destination than the current location and a reservation offer is provided to the requesting subscriber which can then confirm that the offer is accepted if desired. In urban agglomerations vehicles are often in a wait situation such as at a red traffic light or in a traffic congestion. In such a situation the requesting subscriber can use this kind of situation and, when accepting the reservation offer, is provided with a ride to a location, the drop off location, which is closer to the desired destination. Accordingly, the hitchhiking management entity brings the driver and the possible guests together.

Additionally a computer program comprising program code is provided wherein execution of the program code causes the at least one processing unit to execute a method as discussed above or as explained in further detail below.

Furthermore, a carrier comprising the computer program is provided wherein the carrier is one of an electronic signal, optical signal, radio signal, or computer readable storage medium.

It is to be understood that the features mentioned above and features yet to be explained below can be used not only in the respective combinations indicated, but also in other combinations or in isolation without departing from the scope of the present invention. Features of the above-mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements.

FIG. 1 is a schematic view of a situation where different subscribers take images of an environment allowing a hitchhiking management entity to identify vehicles which could offer a ride.

FIG. 2 is a schematic view of an exchange of information between different subscribers with the hitchhiking management entity where a lane of waiting vehicles is provided.

FIG. 3 is a schematic view of an example how a reservation offer can be provided on a mobile phone of a requesting subscriber requesting a ride to a desired destination.

FIG. 4 shows a schematic architectural view with the different interfaces and interactions between the involved functions.

FIG. 5 shows a further schematic architectural view with the different interfaces and interactions between the involved functions.

FIG. 6 shows different flowcharts carried out at the involved entities in a hitchhiking situation.

FIG. 7 shows a schematic view of different flowcharts carried out at the involved entities in a hitchhiking situation.

FIG. 8 shows a schematic view of hitchhiking a route in a retrospective consideration.

FIG. 9 shows a schematic view of a hitchhiking management entity.

FIG. 10 shows a schematic view of a flowchart comprising the steps carried out at a hitchhiking management entity.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

Within the context of the present application, the term “mobile entity” or “user equipment” (UE) refers to a device for instance used by a person (i.e. a user) for his or her personal communication. It can be a telephone type of device, for example a telephone or a Session Initiating Protocol (SIP) or Voice over IP (VOIP) phone, cellular telephone, a mobile station, cordless phone, or a personal digital assistant type of device like laptop, notebook, notepad, tablet equipped with a wireless data connection. The UE may also be associated with non-humans like animals, plants, or machines. A UE may be equipped with a SIM (Subscriber Identity Module) or electronic-SIM comprising unique identities such as IMSI (International Mobile Subscriber Identity), TMSI (Temporary Mobile Subscriber Identity), or GUTI (Globally Unique Temporary UE Identity) associated with the user using the UE. The presence of a SIM within a UE customizes the UE uniquely with a subscription of the user.

For the sake of clarity, it is noted that there is a difference but also a tight connection between a user and a subscriber. A user gets access to a network by acquiring a subscription to the network and by that becomes a subscriber within the network. The network then recognizes the subscriber (e.g. by IMSI, TMSI or GUTI or the like) and uses the associated subscription to identify related subscriber data. A user is the actual user of the UE, and the user may also be the one owning the subscription, but the user and the owner of the subscription may also be different. E.g. the subscription owner may be the parent, and the actual user of the UE could be a child of that parent.

In the following a method and a system is explained in more detail where a vehicle hitchhiking situation is automated and processed using a hitchhiking management entity.

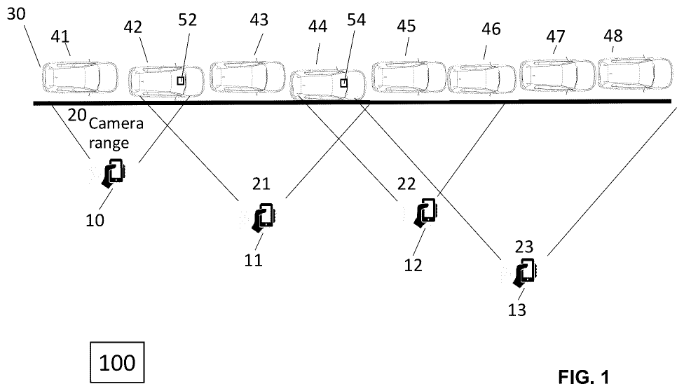

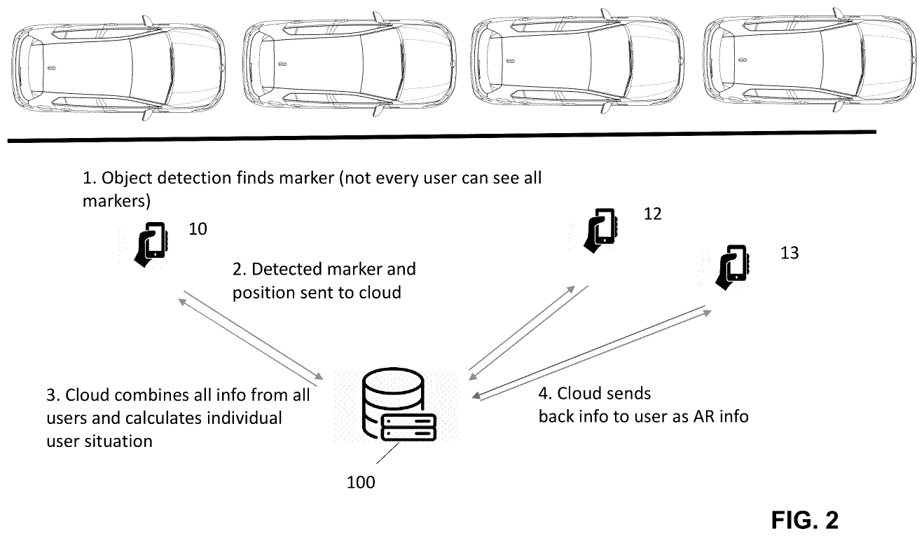

Referring to FIGS. 1 and 2 a hitchhiking management entity 100 is provided which may be implemented as a server accessible to a plurality of subscribers. The hitchhiking management entity 100 may furthermore be implemented in a cloud system. The subscribers to the system include first subscribers which define the subscribers that are currently driving a vehicle and indicate to the management entity 100 which route they take to a desired destination. Accordingly, the first subscribers among the subscribers offer a ride and other subscribers or one other subscriber from the plurality of subscribers will provide a hitchhike request which indicates a current location and a desired destination of the requesting subscriber. The present application is especially designed for urban agglomerations with many vehicles and with a high traffic density so that first of all a high number of cars/vehicles is available and secondly the situation occurs often that a vehicle is not moving, e.g. is waiting at a red traffic light or is in a traffic congestion. It is to be understood that the invention is not limited to urban agglomerations but may also be applied in more rural areas. Furthermore, the present invention is not restricted to a situation where the vehicles providing a ride offer wait at a red traffic light. It is also possible that a vehicle providing a ride moves slowly or is waiting at the border of the road for whatever reason. The method can use optical data such as a camera input from multiple mobile devices or UEs, which are used to generate an overall picture of the hitchhiking situation.

FIG. 1 shows a schematic view of a situation where several subscribers such as subscribers 10, 11, 12 or 13 are standing next to a road and take pictures from the environment. Each of the subscribers takes a picture having a certain field of view such as the field of view 20, 21, 22 or 23. The different subscribers are located next to a road 30 where different vehicles 41 to 48 are located. Preferably, those vehicles are not moving, and they might wait at a traffic light or in a traffic congestion or may even park. Some of the vehicles such as vehicle 42 or 44 can contain a marker such as marker 52 and 54 which can help to identify a subscriber and a corresponding vehicle. The different subscribers 10 to 13 transmit the camera images to the hitchhiking management entity 100, e.g. using a cellular network. The image of each subscriber can include or show different vehicles such as the image taken by subscriber 10 includes vehicles 41 and 42. The entity 100 integrates the images received from the different cameras and creates an overall picture of the car hitchhiking situation. Accordingly, the entity 100 generates a combined image. The combined image can be generated as the different field of views (FOVs) from the different subscribers overlap so that markers on different vehicles, the vehicle itself or any other object shown in the images may be detected and used as a reference. Thus the entity 100 can generate a combined view of the lane of vehicles. Each of the subscribers 10 to 13 may additionally send its position using satellite based positioning systems provided in the UEs. Additionally, information from Wi-Fi or LIDAR systems may be used to localize the subscribers and the different vehicles in the lane.

However, the optical data or images received by entity 100 are not limited to images generated by subscribers. It is also possible that static cameras placed on the side of the road, on buildings or elsewhere close to a road might transmit image data or in general optical data to the entity 100. The advantage of the combined image data is that entity 100 can determine a possible offer for a ride for a vehicle, which is not directly in the field of view of the camera of the requesting subscriber. By way of example in FIG. 1 subscriber 10 may request a ride to a desired destination and vehicle 44 may be a vehicle which can at least take over a part of the route to the desired destination.

In the method discussed below there is no need for a fixed planning and booking of the route beforehand. In an urban agglomeration a vehicle stops frequently for different reasons such as traffic lights. This is a situation where a subscriber requesting a hitchhike can enter or leave the vehicles. It should be understood that both the requesting subscriber and the subscriber offering a ride are registered at entity 100 as a trusted person. Furthermore, it should be understood that the first subscribers providing an offer for a ride also have the option to reject a hitchhiking request. Each, the requesting subscriber and the driver should be registered in the entity 100 with the corresponding personal data. Both, the driver and the requesting subscriber can give their own individual preferences. By way of example, the requesting subscriber which sends a hitchhike request to entity 100 can indicate his or her preferences such as the preference for a direct ride to a destination even if this might need a longer time, especially a longer waiting time for a matching ride. Furthermore, the requesting subscriber can indicate that no toll roads should be used, that the cheapest or the fastest ride opportunity should be selected, that the vehicles should be a non-smoking vehicle etc., Furthermore, the requesting subscriber could indicate that there is situation dependent information such as an attended child, attended luggage, or attended animals such as a dog.

The first subscribers which offer a ride could also indicate further preferences such that no attended child or no attended luggage or no attended animal is desired. Furthermore, the first subscribers enter the planned routes into the system. This could be a daily route to work so that the routes are stored long-term and do not have to be updated every day. If there are multiple repeating routes for one driver, these routes could be stored associated with a corresponding time such as in the morning the route to work, in the evening the route from the work to home. Furthermore, if the route is the same to and from a desired destination the guest's position, i.e. the position of the requesting subscriber in the traffic light place identifies the traveling direction. Otherwise the route is entered when starting to drive.

In order to find a matching route for the requesting subscriber entity 100 starts with the calculation of the best route from the current position of the requesting subscriber to the desired destination, taking into account personal preferences if necessary. Furthermore, possible alternative routes are calculated. Then this route and the possible alternative routes are matched one by one with the route of every vehicle that is detected in the image data provided by the different subscribers or provided from static cameras in the neighborhood of the requesting subscriber. The drivers providing and offering a ride can be identified in the images by markers attached to the windows of the vehicles or to any other part of the vehicle. The marker allows a clear and unambiguous identification of the vehicle or the corresponding subscriber and can represent an identification of the subscriber offering the ride. The entity 100 furthermore determines whether one of the routes which is offered by the different vehicles has a possible drop off location closer to the desired destination than the current location of the requesting subscriber. If this is the case, a reservation offer is provided to the requesting subscriber, which includes reservation information. The reservation information can inter alia include at least an identifier of the subscriber or of the vehicle providing the possible ride. The reservation offer can furthermore include an indication to which extent the current vehicle provides a route to the desired destination. This could include a percentage value that indicates to what extent the preferred route of the requesting subscriber matches the driver's route. Accordingly, the offer can indicate how far the provided ride could bring the guest to the desired destination. The reservation offer can be sent to the subscriber's UE and can be presented to the subscriber on the UE so that the requesting subscriber is informed of the best hitchhiking opportunity.

The requested subscriber can enter the target destination using the mobile device. The requesting subscriber such as subscriber 10 can then wait at a crossway or at any other location and can look for a free ride with one of the passing vehicles. The subscriber can scan the lane of the vehicles with the mobile device and when a marker such as a marker 52 or 54 is detected in the images transmitted to device 100 the entity 100 can process the received pieces of information and the entity 100 can return the reservation offer, which can include different pieces of information in a reservation such as the fitting of the route and the fitting of the guest preferences, the personal information of the driver such as the trustworthiness of the driver, information about the free seats available. FIG. 2 shows an exchange of information between the involved entities. Each of the requesting subscribers such as subscribers 10, 12 or 13 transmits the image data and the position to the hitchhiking management entity 100. Detection of the marker can be made at the UE, the requesting subscriber, or can be made at the hitchhiking management entity 100. Furthermore, each requesting subscriber sends its position to entity 100. Thus, in a first step, the images are taken and as a second optional step, the markers are detected in the images and transmitted to the hitchhiking management entity 100 together with the position. In a third step the hitchhiking management entity combines the information from the different subscribers or from fixed cameras and calculates for the individual users or subscribers the possible reservation offers. Furthermore entity 100 may carry out the identification of the markers in the received images.

Besides the cameras provided at the UEs, additional sensor technology could be used to implement the detection of the markers provided at the vehicles, by way of example Wi-Fi localization or a LIDAR system. It is also possible to use a combined system in which the first detection is done using Wi-Fi and the scan with the mobile device camera detects the side view of the vehicle, which may be stored beforehand by the driver of the car. In such a solution, the marker may not be even visible on the vehicle.

The hitchhiking management entity 100 does a route calculation, wherein the calculation is done for every requesting subscriber by matching its route to the desired target destination with the routes of the vehicles standing in the lane which were detected as having a marker such as the vehicles 42 and 44 in FIG. 1. Input data that is used to calculate the matching of the requesting subscriber's preferred route and the driver's route can include the following pieces of information such as the route of the driver, the desired destination of the requesting subscriber or even the desired route of the requesting subscriber, the location of the traffic light situation, wherein GPS signal can be considered. Furthermore, the driver's preferences and the requesting subscriber preferences can be considered such as local peculiarities. By way of example, it may be known that from a special location it is hard to obtain a next ride. In this context, it is possible to analyze data from past hitchhiking situations and the system can learn from those special circumstances using artificial intelligence or any other methods.

The misfitting of the preferences could result in the possibility that no ride is provided at all. Furthermore, one of the rights may be more attractive than other rights.

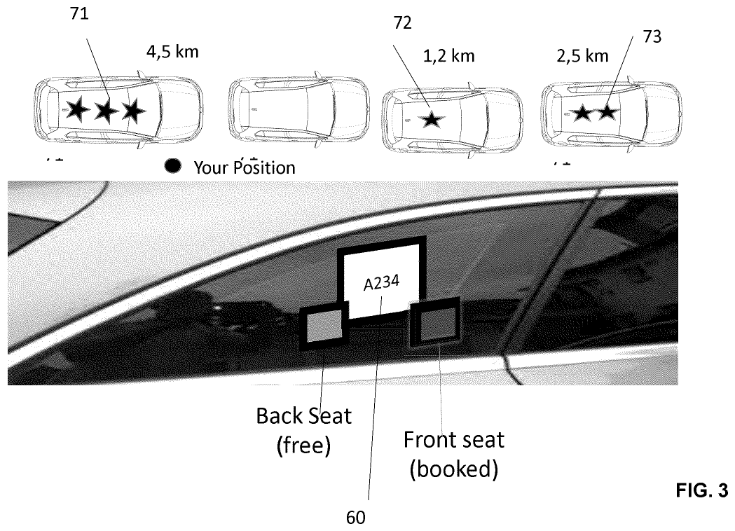

FIG. 3 shows a possible implementation of how a reservation offer is provided to the requesting subscriber. The image shown in FIG. 3 could be presented on requesting user's UE using augmented reality or just a normal image generated at the entity 100 based on the image received from one of the subscribers amended by including information about the reservation offer. Image shows an example of a marker 60 provided at one of the vehicles and the offer can include information for the different vehicles, which could be reserved. Each of the offers could be provided with a matching score such as score 71, 72 or 73, which indicates how far the drop off location is located away from the desired destination or in other words, how far each of the vehicles can take the requesting subscriber. In the example shown the first vehicle having a matching score 71 can give a ride for 4.5 km, the other vehicle can provide a ride for 1.2 km and the third vehicle can provide a ride for 2.5 km. Furthermore, information such as the availability of the free seats can be shown. The user could then select one of the reservation offers provided, wherein this reservation confirmation generated by the requesting subscriber is sent back to the entity 100 where it is transmitted further to the driver the reservation offer of which has been accepted. If the reservation offer includes information which allows a direct contact with the driver offering the ride, it is also possible that the requesting subscriber directly contacts the driver. The driver receives the corresponding notification on his UE including all the relevant information. The driver can then decide whether to accept the request or not. If the request is accepted this information can be sent back to the requesting subscriber either directly or via entity 100. The entity 100 furthermore calculates a drop off location where the guest should be dropped off. This information is provided to the driver so that the driver knows where to offload the hitchhiking subscriber. Furthermore the notification for the drop off can also be triggered by the requesting user requesting a ride itself. This drop off could be located again at a red traffic light or at any other location where the drop off is possible.

Furthermore, it is possible to calculate how long a corresponding vehicle will be still waiting in a position where it is possible to take on a hitchhiking person. The entity 100 could determine how long it takes until the vehicle will move again, by way of example when a red traffic light turns green again. This kind of information could be provided by an operator of the traffic light system, furthermore it is possible that the switch from the green to the red traffic light could be detected by an object detection in the requesting subscriber's mobile entity and a timer for the countdown could be provided based on empirical values. This indication of the time period provided for the boarding situation could be indicated to the requesting subscriber in the reservation offer.

It should be understood that only registered and reliable persons are served by the system described above as both the mobile devices of the driver and the requesting user are registered in the system. An extra protection via near field communication such as NFC or Bluetooth could be established so that it can be ensured that only authorized persons are involved in the boarding.

The marker such as marker 60 shown in FIG. 3 can be used to identify the vehicle. As the requesting subscriber is in a lateral position relative to the vehicle, the number template can normally not be used for this purpose. By marking the own vehicle the driver can show the interest to provide a hike. A marker can be attached to a window of the vehicle. Beside the image data additional sensor or technologies could be used to implement the detection of the vehicle marker on the mobile entity of the requesting subscriber such as Wi-Fi localization or LIDAR. Based on the marker it is possible to identify the driver, the route of the driver, the driver's preferences and the personal information of the driver such as the trustworthiness, the mobile phone number or any payment data. Additional based on the marker the number of free seats available can be provided.

In the following a concrete example is discussed in more detail:

A driver, such as driver A in a certain city such as Boston drives every day the same route to his working place. Because he wants to drive on the fast lane where a minimum of two persons is needed he may decide to register in the hitchhiking or car sharing system as implemented by entity 100. He provides information of the permanently driven route. Furthermore, the driver indicates his preferences such as no smokers or no animals. Furthermore, he can give an indication what the costs are for a certain distance. The driver obtains the marker from the entity 100 which allows the driver to be identified and the marker can be attached to a side window of the vehicle.

Every day the driver can then pin the marker on the window when driving to work. Furthermore, when driving home back from work the requesting subscriber may have a doctor visit it in the same town and wants to drive home. As a taxi may be too expensive and the bus frequency is too low, the subscriber can decide to use the hitchhiking system described above. After having registered he can provide his preferences such as that it should be a non-smoking vehicle. When the requesting subscriber wants to go home, the driver may be waiting at a traffic light system close to the current position. The requesting guest/subscriber can enter the destination into the system and the system could guide the requesting subscriber to the right position at the traffic light location for the desired route. The traffic light is red and a countdown is started and it is known that the red phase will last 50 seconds. This is shown on the UE of the requesting subscriber. The subscriber furthermore scans the lane of waiting vehicles and some of them have markers on the windows. Other subscribers or guests may also scan the same lane. The requesting subscriber gets a reply on the UE suggesting three possible rides to take as shown in FIG. 3. One of these vehicles may have a warning that it is a smoker's vehicle. One of the vehicles may have the best offer such as the best fitting route for the next 20 miles whereas another vehicle can only provide a hike for 5 miles. The system may further indicate that at the drop off location after the 20 miles there is a good chance to get a next ride because this area is at the moment highly frequented by vehicles. The requesting subscriber can then decide to take one of the vehicles. The display of the UE of the requesting subscriber can indicate that the vehicle has still two free seats. By confirming the reservation, the requesting subscriber could reserve one of the seats.

It is possible that the vehicle is not in the scanning radius of the requesting subscriber. However, another subscriber has scanned it and the system has combined the information. Currently there are 40 seconds left until the traffic light turns green again. The mobile device can furthermore show the direction to the suitable vehicle. When the user has accepted the offer, the driver gets the corresponding notification that a seat was reserved. He furthermore obtains the indication that his mobile device has made a connection to the requesting subscriber's mobile device via Bluetooth and that the guest is identified. The driver can now open the door and gets into the car where 20 seconds remain. The driver furthermore obtains the notification that the requesting subscriber wants to leave in a certain distance such as 20 miles. Now he is allowed to use the fast lane. When he reaches the desired drop off location he is informed accordingly, stops and the guest can leave the vehicle. It is also possible that the drop off location is adapted during the trip in view of unforeseen events such as an accident. The requested amount of money is booked from the guest's account to the driver's account. The UE of the requesting subscriber can guide him to the next place to get a next ride which can be again a traffic light. Here the same procedure takes place.

The solution discussed above cannot be applied only for car hitchhiking but also for public transport. By way of example public buses could be registered in the system and the buses get markers and the bus lengths are stored in the system so that whenever a guest is looking for ride to take, the preferred route can be matched with the lanes of buses passing by. In case the bus is a possible ride for the guests to take, additional information can be shown, such as how many seats are still available on the respective bus. This has the advantage that the requesting subscriber does not have to check any bus plans or does not have to go to a fixed place such as a bus stop but could get on the bus at every stop while a bus is waiting during a red traffic light.

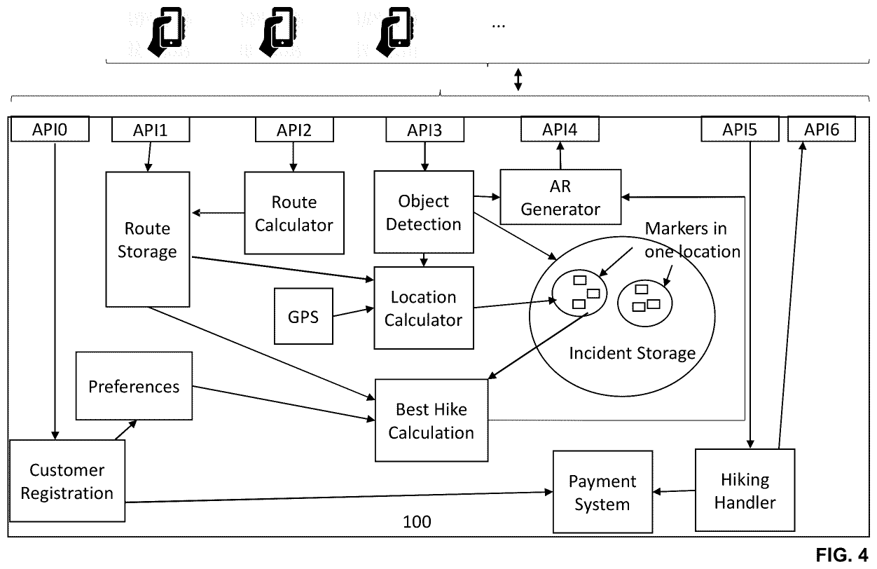

FIG. 4 shows an architectural overview with the different access point interfaces, APIs between the UEs and the hitchhiking management entity.

Following APIs may be involved:

API0: the requesting subscriber and the driver register at the system and provide personal data including payment data and preferences.

API1: the driver provides the daily route and this can be either done directly before starting the route or the route can be stored permanently.

API2: the requesting subscriber provides the desired destination.

API3: the camera of one or other subscribers takes images from the environment including the markers.

API4: the requesting subscriber obtains the instruction such as an augmented reality instruction on the device.

API5: the requesting subscriber interacts with the augmented reality on the device to confirm the offer.

API6: the driver gets the notification to open the door.

The incident storage brings all the information from the phone camera devices and static cameras together. The information is grouped according to locations and the information related to the markers is used for the best hike calculation.

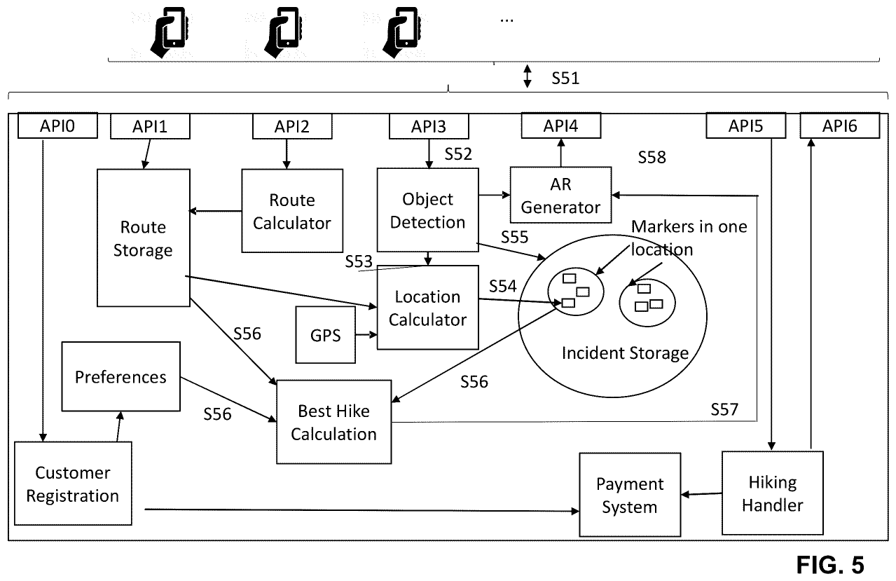

FIG. 5 shows a message flow or a use case. In step S 51, the requesting subscriber scans the lane with the camera of the mobile device. In step S 52, the picture is sent to an object detection and the marker in the vehicle is identified, if this has not been done in the mobile device. In step S 53, the location of the marker is identified using GPS matching methods or a point of intersection can be used to calculate the location of the marker. In step S 54, the location of the marker is sent to the incident storage. In step S 55, the identified marker is sent to the incident storage and here the markers and also the scanned markers from other subscribers or static cameras are grouped per location. In steps S 56, the information about the preferred routes both of the guest and the driver, information from the cameras grouped according to the location and markers grouped according to locations is sent to the best hike calculation and the fitting of the hikes is calculated. In step S 57, the information about the fitting of the hikes is sent to the augmented reality generator and in step S 58 the information is preprocessed, individualized and sent to the subscriber.

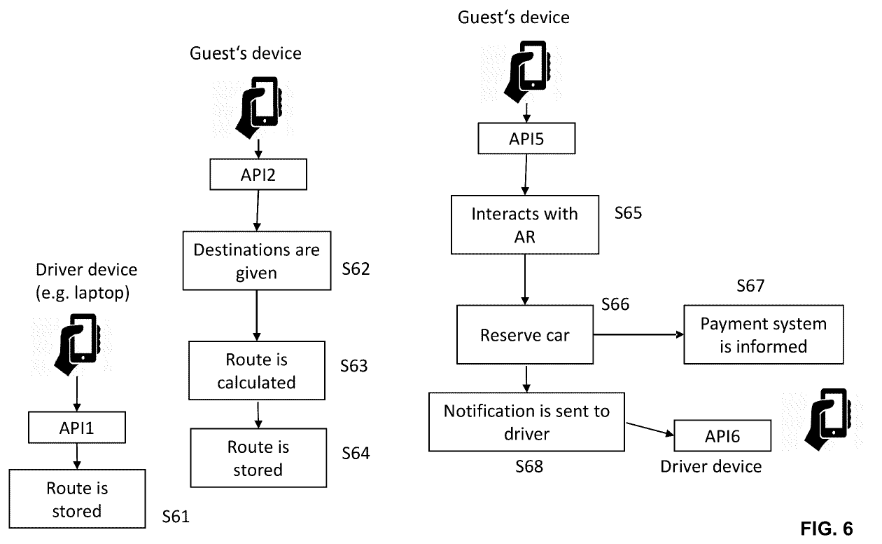

FIG. 6 summarizes some of the steps carried out for the involved entities and APIs. These steps are carried out at the hitchhiking management entity. As far as the driver offering a ride is concerned, the driver may use any computer connected to the hitchhiking management entity and the driver informs the entity 100 of the route he or she is currently taking (S61). It may be a single route or may be pre-stored pattern of route, by way of example in the morning to work and in the afternoon back from work. As far as the requesting user is concerned, the hitchhiking management entity, using a further interface, receives the destination or destinations given for the subscribers requesting a ride (step S 62). In step S 63, the route to the desired destination is calculated wherein it is possible that different routes to the desired destination are calculated. The route or the several routes are then stored within the hitchhiking management entity 100 (S 64). When the requesting subscriber has confirmed a ride, the subscriber interacts with the augmented reality in step S 65 and reserves a car or vehicle in step S 66 and the payment system is informed of the vehicle reservation in step S 67 and a notification is sent to the driver, either directly from the requesting subscriber or via the hitchhiking management entity. After this step S 68 the information is sent to the driver device.

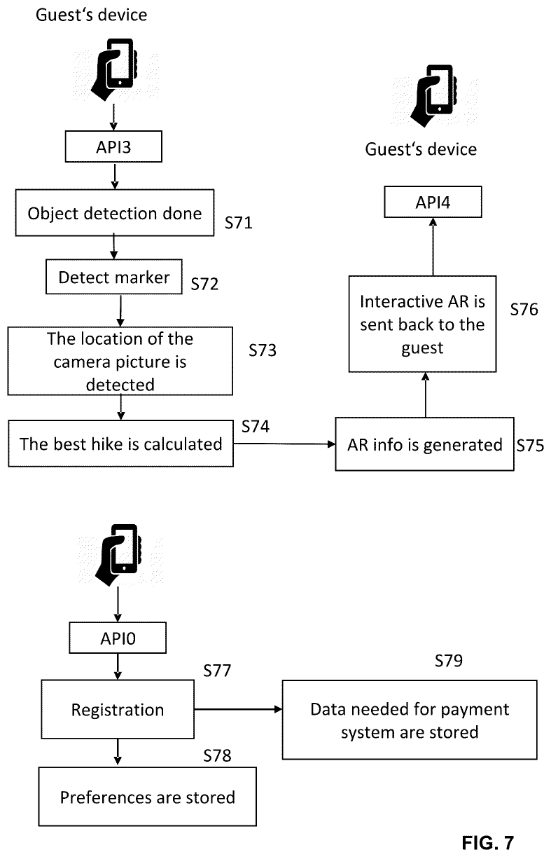

FIG. 7 shows how the best matching option is determined for the requesting subscriber. In step S 71, after having received the video or image data from the subscribers or from fixedly installed cameras, an object detection is carried out in order to detect the different waiting vehicles. In step S 72, a possible marker attached to a vehicle is detected and in step S 73 the location or the point of view where the picture was taken is determined. When the best hitchhiking or car sharing option is calculated (S 74) information is generated for the requesting subscriber allowing the subscriber to identify the corresponding vehicle. This information can be displayed using augmented reality, however any other way to inform the requesting user of the corresponding vehicle may be used. By way of example based on the marker the license plate may be registered in the entity 100 and simply the information of the license plate may be displayed to the user so that the user knows which vehicle to select. After this step S 75 the generated information is sent back to the requesting subscriber (S 76).

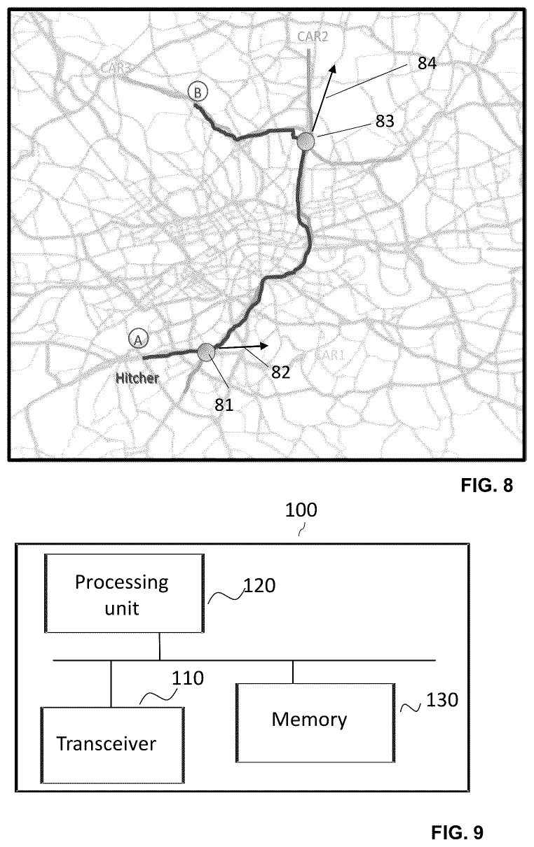

FIG. 8 shows a route as taken by one requesting subscriber in retrospect. The hitchhiker start from point A where a first vehicle is used until point and drop off location 81. The first vehicle continues in the direction of the arrow 82. Here, the user changes vehicle and the second vehicle takes the user from drop off location 81 to drop off location 83. The second vehicle continues in direction of location 84. Here, the driver again changes vehicle and the third vehicle brings the requesting subscriber from drop off location 83 to the destination B. At both locations or drop off locations 81 and 83 the user changes the vehicle and in both cases the same procedure is carried out which was discussed above. Please note that there is no reservation for a hike for third car, which takes place while the user is riding on the second car.

FIG. 9 shows a schematic architectural view of the hitchhiking management entity 100, which can carry out the above, discussed steps. The hitchhiking entity comprises an interface 110, which can symbolize the different APIs shown in FIG. 4 or 5. The interface 110 is provided for transmitting information to other entities such as the UEs and is configured to receive information from other entities such as the UEs. The interface 110 is especially qualified to receive the image data from the UEs and is configured to transmit a reservation offer to the requesting subscriber and a reservation confirmation to the driver. The entity furthermore comprises a processing unit 120, which is responsible for the operation of the hitchhiking management entity 100. The processing unit 120 comprises one or more processors and can carry out instructions stored on a memory 130, wherein the memory may include a read-only memory, a random access memory, a mass storage, a hard disk or the like. The memory can furthermore include suitable program code to be executed by the processing unit 120 so as to implement the above described functionalities, in which the hitchhiking management entity is involved. It should be understood that the entity 100 may not be implemented as entity implemented in a single housing, it may be implemented in a cloud infrastructure.

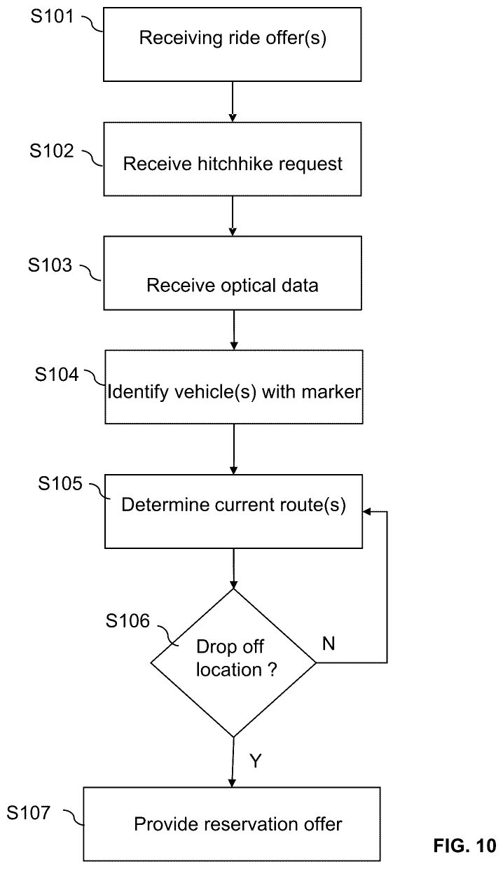

FIG. 10 summarizes some of the steps carried out at the hitchhiking management entity. In step S 101, the hitchhiking management entity receives at least from one first subscriber driving a vehicle a ride offer including a current route to a corresponding destination. In step S 102, the entity 100 receives from a requesting subscriber a hitchhike request, which comprises at least a current location and a desired destination of the requesting subscriber. The entity 100 furthermore receives in step S 103 optical data, such as image data showing a surrounding of the current location of the requesting subscriber. In step S 105 a vehicle from one of the first subscribers is identified based on a marker which is present in the optical data, wherein the identified vehicle provides a possible ride. The entity 100 determines in step S 105 a current route and in step S 106 it is determined whether the current route of the at least one vehicle has a drop off location closer to the desired destination than the current location. If this is the case, in step S 107 a reservation offer is provided to the requesting subscriber indicating reservation information. The reservation information can contain several pieces of information such as an identifier of the at least one vehicle, which provides the possible ride.

The score for determining how good the offered ride corresponds to the requesting subscriber, could be determined using a formula which uses additive and/or multiplying components as will be discussed in more detail below. Besides the distance which is possible to drive with this vehicle in the wished direction there are additional components which can be considered as follows:

$$Score = D 1 ( d 1 , g 1 ) x D 2 ( d 2 , g 2 ) x …$$

Dn: Comparison function if drivers and guest profiles matches
Dn results in 0 or 1
dn and gn are input parameter for the Comparison function; d drivers profile, g guests profile
This could exclude a driver as a potential partner for this guest and the other way around
d1: guest Smoker
g1: driver do not allow smoking
d2: driver Smoker
g2: for guest driving in a smoker car is a no-go
d3: pets forbidden
g3: guest want to transport pet
d4: luggage forbidden
G4: guest has luggage
. . .

$$Score = … C 1 ( d 1 , g 1 ) x C 2 ( d 2 , g 2 ) x …$$

Cn: Comparison function if drivers and guest profiles lead to mismatch
Cn can result in any values and is used as a weight function
dn and gn are input parameter for the Comparison function; d drivers profile, g guests profile
d1: guest Smoker
g1: driver do not allow smoking

$$Score = … x W ( t , d ) x … .$$

W: weight factors as a function of parameters
d: distance to car
t: remaining time until traffic light switches to green
W(t, d): chance to reach this car during the red phase; time depended: changes every second

$$Score = … x E ( t , p , En ) x … .$$

E(t, p, En): chance to get another ride at the endpoint of the ride
t: estimated arrival time
p: endpoint of ride
En: diverse input data (input from other cars in the system, outside the system info like traffic count systems . . . )
The function E calculates the estimated riding situation at the endpoint of the ride.

From the above said and the above explanation some further general conclusions for the method carried out at the hitchhiking management entity can be drawn.

The hitchhiking management entity may furthermore receive a reservation confirmation of the requesting subscriber and may transmit the reservation confirmation to the identified at least one vehicle. Here, the hitchhiking management entity is involved in the process. Furthermore, it is possible that the requesting subscriber directly contacts the at least one vehicle which provides the ride offer. This is possible when the hitchhiking management entity provides an identifier in the reservation offer which allows the requesting subscriber to directly contact the vehicle and driver offering a ride.

When the drop off location is determined, it is possible to determine a traffic density along the current route to the corresponding destination and to select a possible drop off location only as the actual drop off location if an expected traffic density at the possible drop off location is higher than a threshold value. This may happen when the drop off location is located further away from the desired destination than a predefined threshold so that a further hitchhiking opportunity is needed to arrive at the desired destination. If the drop off location is within a certain distance from the final desired destination the requesting subscriber wants to reach, the drop off location may be selected independent of the traffic density. The higher traffic density may be desired in order to increase the chances that a further hitchhiking opportunity will be found at the drop off location.

Furthermore, it is possible that the hitchhiking management entity 100 determines a matching score which represents a distance how far the drop off location is located away from the desired destination wherein the matching score is added to the reservation offer. Reference is made in this context to FIG. 3 where a possible matching score 71 or 72 is indicated for the corresponding vehicles.

Furthermore, it is possible that the received optical data comprise partial images generated by different image acquisition units located in the surrounding of the current location of the requesting subscriber. The hitchhiking management entity then combines partial images to combined optical data or to a combined image and the at least one marker is determined in the combined optical data as was discussed above in connection with FIG. 1.

The partial images may be received from several subscribers or from fixedly installed cameras installed in the surrounding.

Furthermore, it is possible that the hitchhiking management entity 100 identifies several markers in the optical data. The entity 100 determines for each of the identified markers the current route to the corresponding destination, wherein a possible drop off location is determined for each identified marker. The possible drop off location is added to the reservation offer. The possible drop off location may be added by indicating the overall distance that can be obtained when taking the ride or can include a name or place of the drop off location or the coordinates of the drop off location.

Here, it is possible that the matching score representing the distance how far the drop off location is located away from the desired destination is determined for each of the markers, and the adding of the possible drop off location comprises adding a score for each marker to the reservation offer.

Furthermore, it is possible to determine a subscriber profile of the requesting subscriber, which includes preferences of the requesting subscriber for the possible ride. Furthermore, a driver profile is determined for each of the identified markers, which indicates the preference of the driver driving the corresponding vehicle. The subscriber profile is matched with each of the driver's profile and a score could be determined based on the matching for each of the markers, wherein the score is added to the reservation offer for each of the markers. With this feature the requesting subscriber and the driver can determine whether the offer and the request fit together.

Furthermore, it is possible that the score for each of the markers is weighted by a weighting factor in order to determine a final score for each of the markers, wherein the weighting factor depends on at least one of a distance of the requesting subscriber to the corresponding marker and an estimated stopping period in which the corresponding marker or the vehicle is not moving. This helps to determine whether the requesting subscriber is able to reach the vehicle providing the offer within a time period where the vehicle offering the ride is not moving.

The determination step whether the current route of the at least one vehicle has a drop off location closer to the desired destination can contain the steps of determining different alternative routes to the desired destination and it can be determined to what extent the alternative routes match with the current route of the at least one vehicle. The best matching route of the alternative routes is then selected for the requesting subscriber and the drop off location is then determined for the best matching route.

Furthermore, it is possible to determine for each of the at least one marker determined in the optical data a value which indicates to what extent the possible ride provided by the corresponding vehicle matches a possible route to the desired destination and this value may be transmitted for each marker to the requesting subscriber.

The value may be a percentage value or a distance value and may be added to the reservation offer. Accordingly, the requesting user knows to what extent the offered ride corresponds to the route to the desired destination.

The reservation offer may comprise furthermore a number of free seats for a ride, the possibility to take on luggage, the possibility to take animals, information whether smoking is allowed etc.

The hitchhike request can furthermore contain additional input such as the information to select a cheapest route to the desired destination, the information to avoid toll roads, the information to select a fastest route to the desired destination, a preference for a non-smoking vehicle for the possible ride, an amount of luggage to take, information about an accompanying animal or person. The determination of the at least one vehicle which provides a possible ride can then be determined taken into account this additional input from the requesting subscriber.

The entity 100 can furthermore determine a 3-dimensional model of the surrounding of the current location based on the received optical data and can determine a position of the at least one vehicle providing the possible ride and of the subscriber requesting the ride in the 3-dimensional model. Furthermore, a direction indication indicating in which direction the requesting subscriber has to move is determined in order to find the at least one vehicle which provides the possible ride. This destination indication can then added to the reservation offer so that the requesting subscriber knows how to move in order to find the vehicle providing the possible ride. Furthermore, the entity 100 can generate from the received optical data scene data, which indicates a view of the surrounding of the requesting subscriber as seen by the requesting subscriber. The reservation offer is then added to the scene data in order to generate an augmented reality scene, which is transmitted to the requested subscriber.

The surrounding of the current location as displayed in the optical data may include at least one lane of non-moving vehicles. The non-moving vehicles may be waiting at a red traffic light and it is possible to further determine a duration how long the at least one vehicle providing the possible ride will not move while waiting at the red traffic light, wherein the duration is added to the reservation offer. The optical data, which are received, may also contain at least data from the requesting subscriber, but also from other subscribers or from fixedly installed cameras.

Summarizing a method is provided which allows hitchhiking on direct demand, wherein only the target destination is specified and for getting into a vehicle the wait situation at a red traffic light may be used. Camera input from multiple subscribers or mobile devices can be used to generate an overall picture of the hitchhiking or car sharing situation. Optical markers taking the vehicles may be used to identify the vehicle with the most suitable ride and can bring the guest or requesting subscriber and the driver together. Comfortable constellation of hitchhiking routes may be calculated and the resulting hitchhiking route can be presented on the UE of the requesting subscriber using augmented reality.

1. A method carried out at a hitchhiking management entity, the method comprising:
receiving, from at least one first subscriber driving a vehicle among a plurality of subscribers, a ride offer including a current route to a corresponding destination,
receiving, from a requesting subscriber from the plurality of subscribers a hitchhike request comprising a current location and a desired destination of the requesting subscriber,
receiving, from at least one of the plurality of subscribers, optical data showing a surrounding of the current location of the requesting subscriber,
identifying, based on at least one marker in the optical data provided on one of the vehicles from the first subscribers, at least one vehicle providing a possible ride,
determining the current route of the identified at least one vehicle,
determining whether the current route of the at least one vehicle has a drop off location closer to the desired destination than the current location, wherein in the affirmative,
providing a reservation offer to the requesting subscriber indicating reservation information comprising at least an identifier of the at least one vehicle providing the possible ride.

2. The method of claim 1, further receiving a reservation confirmation of the requesting subscriber and transmitting the reservation confirmation to the identified at least one vehicle.

3. The method of claim 1, wherein determining the drop off location comprises determining a traffic density along the current route to the corresponding destination and a possible drop off location is only selected as drop off location if an expected traffic density at the possible drop off location is higher than a threshold value.

4. The method of claim 1, further determining a matching score representing a distance how far the drop off location is located away from the desired destination, wherein the matching score is added to the reservation offer.

5. The method of claim 1, wherein the received optical data comprise partial images generated by different image acquisition units located in the surrounding of the current location of the requesting subscriber, wherein the partial images are combined to combined optical data, and the at least one marker is determined in the combined optical data.

6. The method of claim 5, wherein the partial images are received from several of the plurality of subscribers or from fixedly installed cameras installed in the surrounding.

7. The method of claim 1, further comprising:
identifying a plurality of markers in the optical data,
determining, for each identified marker the current route to the corresponding destination, wherein a possible drop off location is determined for each identified marker,
adding the possible drop off locations to the reservation offer.

8. The method of claim 7 further comprising:
determining a matching score representing a distance how far the drop off location is located away from the desired destination, wherein adding the possible drop-off location comprises adding the matching score for each marker to the reservation offer.

9. The method of claim 7, further comprising:
determining a subscriber profile of the requesting subscriber including preferences of the requesting subscriber for the possible ride,
determining, for each of the identified markers, a driver's profile, indicating preferences of a driver driving the corresponding vehicle,
matching the subscriber profile with each of the driver's profile,
determining a score based on the matching for each marker,
adding the score to the reservation offer for each of the markers.

10. The method of claim 9, wherein each score is weighted by a weighting factor in order to determine a final score for each of the markers, the weighting factor depending on at least one of a distance of the requesting subscriber to the corresponding marker and an estimated stopping period in which the corresponding marker is not moving.

11. The method of claim 1, wherein determining whether the current route of the at least one vehicle has a drop off location closer to the desired destination comprises:
determining different alternative routes to the desired destination,
determining to what extend the alternative routes match with the current route of the at least one vehicle,
selecting a best matching route of the alternative routes for the requesting subscriber,
determining the drop off location for the best matching route.

12. The method of claim 1, further determining, for each of the at least one marker determined in the optical data, a value indicating to what extent the possible ride provided by the corresponding vehicle matches a possible route to the desired destination and the value for each marker is transmitted to the requesting subscriber.

13. The method of claim 12, wherein the value is one of a percentage value and a distance value and is present in the reservation offer.

14. (canceled)

15. The method of claim 1, wherein the hitchhike request comprises additional input comprising at least one of the following: information to select a cheapest route to the desired destination, information to avoid toll roads, information to select a fastest route to the desired destination, a preference for a non-smoking vehicle for the possible ride, an amount of luggage to take, information about an accompanying animal or person, wherein the at least one vehicle is determined taking into account the additional input.

16. The method of claim 1, further comprising:
determining a 3-dimensional model of the surrounding of the current location based on the received optical data,
determining a position of the at least one vehicle providing the possible ride and of the requesting subscriber in the 3-dimensional model,
determining a direction indication indicating in which direction the requesting subscriber has to move in order to find the at least one vehicle providing the possible ride,
adding the destination direction to the reservation offer.

17. The method of claim 16, further generating, from the optical data, scene data indicating a view of the surrounding of the requesting subscriber as seen by the requesting subscriber, wherein the reservation offer is added to the scene data in order to generate an augmented reality scene which is transmitted to the requesting subscriber.

18. The method of claim 1, wherein the surrounding of the current location includes at least one lane of non-moving vehicles, wherein the non-moving vehicles are waiting at a red traffic light, the method further comprising determining a duration how long the at least one vehicle providing the possible ride will not move while waiting at the red traffic light, wherein the duration is added to the reservation offer.

19. (canceled)

20. The method of claim 1, wherein the optical data comprises image data from the requesting subscriber.

21. A hitchhiking management entity comprising a memory and at least one processing unit, the memory containing instructions executable by the at least one processing unit, wherein the hitchhiking management entity is configured to:
receive, from a plurality of first subscribers driving a vehicle among a plurality of subscribers, a ride offer including a current route to a corresponding destination,
receive, from a requesting subscriber from the plurality of subscribers a hitchhike request comprising a current location and a desired destination of the requesting subscriber,
receive, from at least one of the plurality of subscribers, optical data showing a surrounding of the current location of the requesting subscriber,
identify, based on at least one marker in the optical data provided on one of the vehicles from the first subscribers, at least one vehicle providing a possible ride,
determine the current route of the identified at least one vehicle,
determine whether the current route of the at least one vehicle has a drop off location closer to the desired destination than the current location, wherein in the affirmative,
provide a reservation offer to the requesting subscriber indicating reservation information comprising at least an identifier of the at least one vehicle providing the possible ride.

22-40. (canceled)

41. A non-transitory computer-readable medium storing thereon program code to be executed by at least one processing unit of a hitchhiking management entity, wherein execution of the program code causes the at least one processing unit to carry out the method of claim 1.

42. (canceled)
